(19) United States
(12) Patent Application Publication
(10) Pub. No.: US 2009/0303185 A1
(43) Pub. Date: Dec. 10, 2009

(54) USER INTERFACE, DEVICE AND METHOD FOR AN IMPROVED OPERATING MODE

(75) Inventors: Christian Bryske Larsen, Frederiksberg (DK); Pia Breum Nielsen, Kobenhavn S (DK)

Correspondence Address: Perman & Green, LLP, 99 Hawley Lane, Stratford, CT, 06614, US

(73) Assignee: NOKIA CORPORATION, Nokia Group (FI)

(21) Appl. No.: 12/133,118

(22) Filed: Jun. 4, 2008

(51) Int. Cl. G09G 5/00

(52) U.S. Cl. 345/168

(57) ABSTRACT

A user interface configured to detect a first press on a volume key and upon the detection determine a second operating mode and switch from a first operating mode to the second operating mode.

### FIELD

The present application relates to a device and a method for operating modes, and in particular to a device and a method for switching operating modes.

### BACKGROUND

More and more electronic devices such as mobile phones, MP3 players, Personal Digital Assistants (PDAs) are becoming smaller and smaller while having more and more information stored and/or accessible through them. Users are relying on these devices and becoming all the more dependant on them. Due to this they are designed to be small and easy to carry around. However, as the user carries his device with him he will sometimes be in situations or environments where the standard settings of the device is not suitable, for example the ringing tone may be too loud, too soft or perhaps the device shouldn't make any sound at all. But, to change the settings for each occasion can be a difficult task for some users and it is surely a time and cognitive effort consuming task that needs to be repeated each time the user wants to change environment.

Contemporary devices have solved this by implementing devices with pre-defined and customizable setting modes, also commonly referred to as profiles. Each of these profiles contain a set of parameters controlling features such as ringing tune, ringing volume, incoming message alert, vibrator or vibra alert etc. This has provided a possibility for users to quickly change more than one setting at a time. As most contemporary devices are quite complex they also have a rather advanced menu system, which can sometimes be difficult or cumbersome to quickly access applications through. Several solutions have been proposed and used over the years such as dedicated buttons, short cuts, alternative functions for buttons and so on to allow a user to more quickly access a function, such as the profile change. Some known solutions for profile switching are described below.

The environments in which these devices are used are also becoming more and more hectic with higher demands on fast access and multitasking, and not only in a professional environment but also in private and social environments. For example a user should be able to read a book, while holding a grocery bag in a rattling subway train and still be able to access the information stored in the device for the device to live up to the many requirements posed upon it by a user buying and using the device. This poses strict requirements on fast and easy access to data and functions.

Dedicated button, the Nokia Communicator™ 9210, for example, has a dedicated button used solely for accessing the profile menu from which a user can quickly change or customize a profile to his liking. Although being a fast and intuitive way of accessing the profile menu, this has the disadvantage that it requires one extra button which is both costly and requires extra space and puts further constraints on the design, factors which both lead to increased cost and also makes it difficult to design small and light-weight devices.

Shortcuts, many devices have shortcuts to special functions, which can also be user selectable. For example a press on the navigation key in idle mode may act as a shortcut to start up an application, which application could be the profile menu. This allows quick access to some applications but it has the disadvantages that the shortcuts are usually hidden and thus difficult to remember and also to discover them or deduce their existence and function. Thy also have the disadvantage that as more and more applications and features are implemented in a device, there is simply not enough keys to assign shortcuts to without causing a new and complicated menu structure to be implemented for the shortcuts which serves to further complicate the user interface instead of making it more intuitive.

Alternative functions for a key; in some devices such as mobile phones it is common to have the power key to have an alternative function. When it is pressed for a longer time, ie a long-press as is commonly known in the filed of user interfaces for small portable devices, a profile menu is activated from which the user can select a new profile to be used or to turn off the phone. This has the disadvantage that there is no logical connection between the power key and the profiles so it is difficult for a user to learn or to deduce its existence.

Another example is to assign an alternative function to the ‘#’-key, which is part of the ITU-T keypad commonly used for portable devices such as mobile phones. By making a long-press on the ‘#’-key in idle mode of a phone, the profile is switched from General (indicating normal ringing tone, average volume) to Silent (indicating no sounds). This has the disadvantage that there is no logical connection between the ‘#’-key and the profile switching, especially not since the ‘#’-key is most commonly used in text input to change the case of the input or toggle between alternative input modes. It also makes it impossible to use the ‘#’-key to switch modes while for example editing a text message.

The process of deducing a key's function is very important in user interfaces for portable devices as most users do not read the manual as well as they should and most often simply start using the device without looking at the manual at all. It is therefore of great importance for a device's success that tit is easy to learn and intuitive to use and it is therefore important that it is easy to deduce or reason to an alternative function of a key. If the user's can't learn all the functions of a device the les likely the device is to become a success.

A device that allows an easy way to change the profile or operating mode on while not requiring additional hardware and which is easy and intuitive to learn would thus be useful in modern day society.

### SUMMARY

On this background, it would be advantageously to provide a device and a method that overcomes or at least reduces the drawbacks indicated above by providing a user interface configured to assign the function of switching operating modes or profiles on the volume keys.

This provides an intuitive way of switching between profiles as most profiles comprise settings for controlling the audio of a device and is thus logically connected to the volume key. By realizing this and thus assigning the profile switching function to the volume keys a user is provided with a way of switching profiles that is both easy and intuitive to use and to learn and also easy to deduce from trial and error usage of a device.

The disclosed embodiments provide a user interface configured to detect a first press on a volume key and upon said detection determine a second operating mode and switch from a first operating mode to said second operating mode.

In one embodiment the user interface is further configured to display a graphical indication of said second operating mode on a display operatively coupled to said user interface. This graphical indication allows for a user to become aware that a profile switch is imminent and to which profile it will be switched to.

In one embodiment the user interface is further configured to detect a second press on a volume key and upon said detection determine a further second operating mode.

This allows a user to select from a number of profiles or operating modes by repeatedly pressing on a volume key, scrolling (back and forth) through a list of available profiles.

In one embodiment the first press on a volume key is a long-press. A long-press is to be understood to be a press on a key that exceeds a threshold value in relation to the length of time that the key is pressed as is commonly known in the field of user interfaces for portable devices.

This allows the teachings herein to be more adaptable and compatible to cooperate with other functions and applications in a device by resolving functional conflicts for application using the same volume keys for different reasons.

In one embodiment the user interface is further configured to detect a press on a non-volume key and upon such detection switch to said second operating mode.

By detecting a press on a non-volume key a user can easily inform and instruct the user interface that the selected profile is the requested one and that a switch to that profile should be executed.

In one embodiment the user interface is further configured to detect a timeout and upon such detection switch to said second operating mode. If a user does not take any action in a given, possibly pre-specified time period a timeout is detected as is commonly known in the field of user interfaces, and upon such detection it is assumed that the user approves of the determined second operating mode and that a switch to this mode should be executed as no further input has been given. This allows a user to switch operating modes without explicitly giving an accept command.

In one embodiment the second key press is a short-press. A short-press is to be understood to be a press on a key that lasts for a normal time period. What is considered to be normal depends on the user group and the device as is commonly known to all skilled men in the field of user interfaces. A short-press is easily distinguishable from a long-press by being a key press lasting for a shorter time than the determined threshold value used for a long-press as explained above.

In one embodiment the second operating mode is determined by selection from a list of operating modes.

In one embodiment the second operating mode is the operating mode next to the first operating mode in the list.

In one embodiment the list of operating modes is arranged in an order of loudness. Arranging the list in order of loudness provides for an even more intuitive coupling of the volume key to the profiles and the function of this feature and its connection to the volume keys is thus even easier to deduce for a user perhaps through trial and error usage of the user interface.

In one embodiment the user interface is further configured to re-arrange said list of operating modes upon switching to said second operating mode, by inserting said second operating mode first in said list of operating modes.

By re-arranging the list of available operating modes in this manner the most commonly used profiles are always at the top of the list and thus easily accessible.

In one embodiment the operating mode comprises control settings for at least one feature taken from a group comprising: ringing tune, vibra, ringing tune volume, incoming message alert, general notification, incoming voice call alert.

The aspects of the disclosed embodiments are also directed to providing a device incorporating and implementing or configured to incorporate and implement a user interface according to above.

In one embodiment the device is a mobile communication terminal or a personal digital assistant.

Such a device has the same advantages of the user interface above.

The aspects of the disclosed embodiments are also directed to providing a computer readable medium including at least computer program code for controlling a user interface, said computer readable medium comprising software code for detecting a key press on a volume key, software code for determining a second operating mode, and software code for switching to said second operating mode from a first operating mode.

In one embodiment the computer readable medium further comprises software code for detecting a second press on a volume key and for upon said detection determine a further second operating mode.

In one embodiment the computer readable medium the first press on a volume key is a long-press.

The aspects of the disclosed embodiments are also directed to providing a device incorporating and implementing a computer readable medium according to above.

The aspects of the disclosed embodiments are also directed to providing a method for switching from a first operating mode to a second operating mode, comprising detecting a first press on a volume key, determining said second operating mode and switching to said second operating mode.

This method and the embodiments below have the same advantages as are outlined above.

In one embodiment the method further comprises displaying a graphical indication of said second operating mode.

In one embodiment the method further comprises detecting a second press on a volume key and determine a further second operating mode to be used as said operating mode.

In one embodiment the first press on a volume key is a long-press.

In one embodiment the method further comprises detecting a press on a non-volume key and then execute said switch to said second operating mode.

In one embodiment the method further comprises detecting a time out and then execute said switch to said second operating mode.

In one embodiment the second press on a volume key is a short press.

In one embodiment the method further comprises determining said second operating mode from a list of operating modes.

In one embodiment the method further comprises rearranging said list of operating modes by inserting said second operating mode in the beginning of said list of operating modes.

The aspects of the disclosed embodiments are also directed to providing a device incorporating and implementing or configured to incorporate and implement a user interface according to above.

The aspects of the disclosed embodiments are also directed to providing a graphical indication comprising a graphical data indicative of control settings for an operating mode.

Such a graphical indication informs a user of the control settings for an operating mode in a space-saving and intuitive way.

In one embodiment the graphical data comprises at least on graphical icon representative of an audible function, a visible function or a tactile function.

The aspects of the disclosed embodiments are also directed to providing a user interface configured to display a graphical indication of an operating mode according to above on a display.

In one embodiment the user interface is further configured to display a list of operating modes and corresponding graphical indications according indicating control settings for each operating mode.

The aspects of the disclosed embodiments are also directed to providing a device incorporating and implementing a user interface according to above.

The aspects of the disclosed embodiments are also directed to providing a method of displaying graphical indicators according to above comprising displaying a list of operating modes and for each displayed operating mode display a corresponding graphical indicator indicating control settings for the corresponding operating mode.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIG. 2 is a plane front view of a device according to an embodiment,

FIG. 3 is a block diagram illustrating the general architecture of a device of FIG. 2 in accordance with the present application,

FIG. 4 is a plane view of a device according to an embodiment,

FIGS. 5A, B, C and D are flow charts or state diagrams describing a method according to an embodiment,

FIGS. 6A and B are flow charts describing each a method according to an embodiment,

FIG. 7 is a screen view of a user interface according to an embodiment, and

FIG. 8 is a view of graphical indications according to an embodiment of the application.

### DETAILED DESCRIPTION

In the following detailed description, the device, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

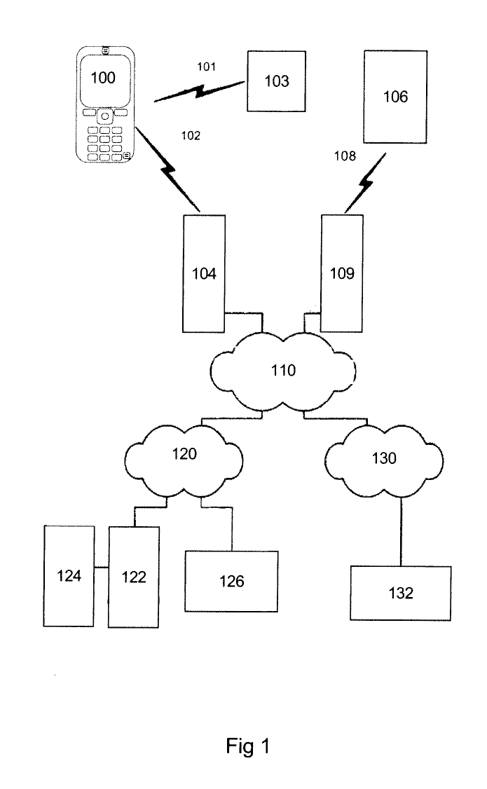

FIG. 1 illustrates an example of a cellular telecommunications system in which the teachings of the present application may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, etc. The local devices 103 can for example be various sensors that can communicate measurement values to the mobile terminal 100 over the local link 101.

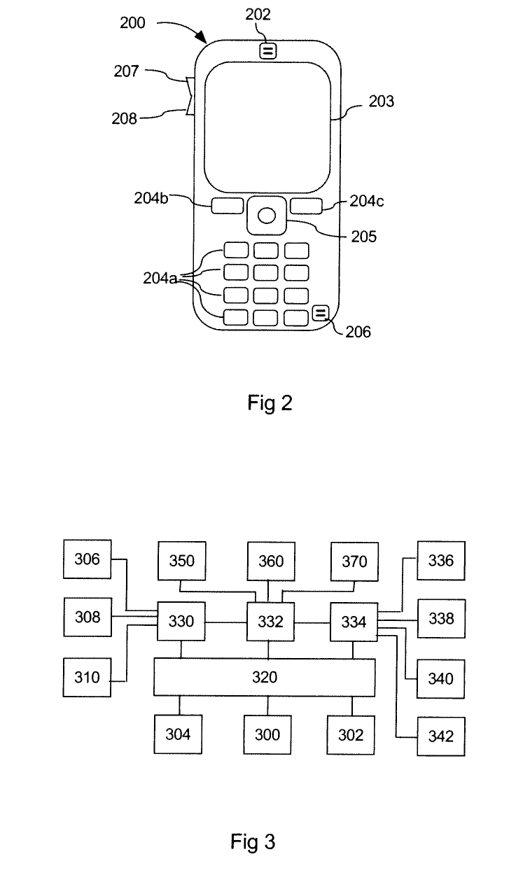

An embodiment 200 of the mobile terminal 100 is illustrated in more detail in FIG. 2. The mobile terminal 200 comprises a speaker or earphone 202, a microphone 206, a main or first display 203 and a set of keys 204 which may include a keypad 204a of common ITU-T type (alpha-numerical keypad representing characters “0”-“9”, “*” and “#”) and certain other keys such as soft keys 204b, 204c and a joystick 205 or other type of navigational input device. The device is also equipped with one or two volume keys 207 and 208. If one key 207 is used it is usually a two-way key each direction being associated with either volume up or volume down. If two keys are used one is associated with volume up 207 and the other with volume down 208.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, etc. It should be noted that two or more of the applications listed above may be executed as the same application

The MMI 334 also includes one or more hardware controllers, which together with the MMI drivers cooperate with the first display 336/203, and the keypad 338/204 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

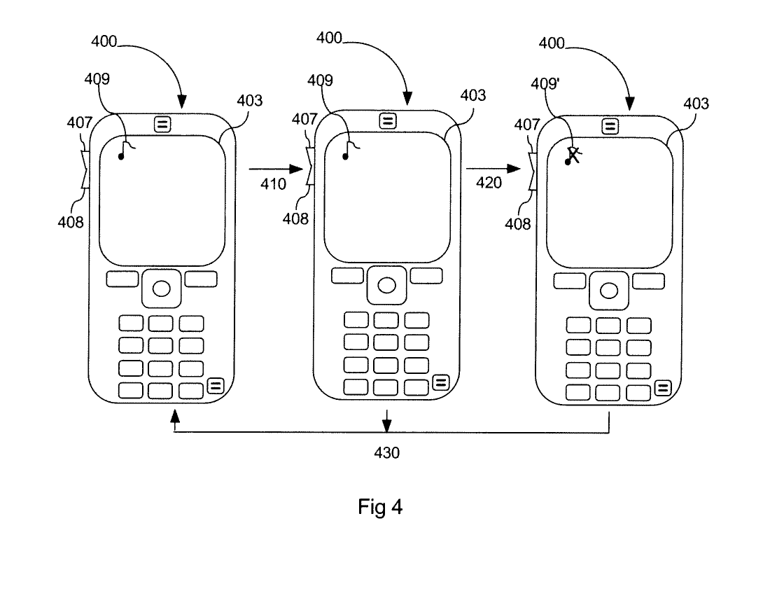

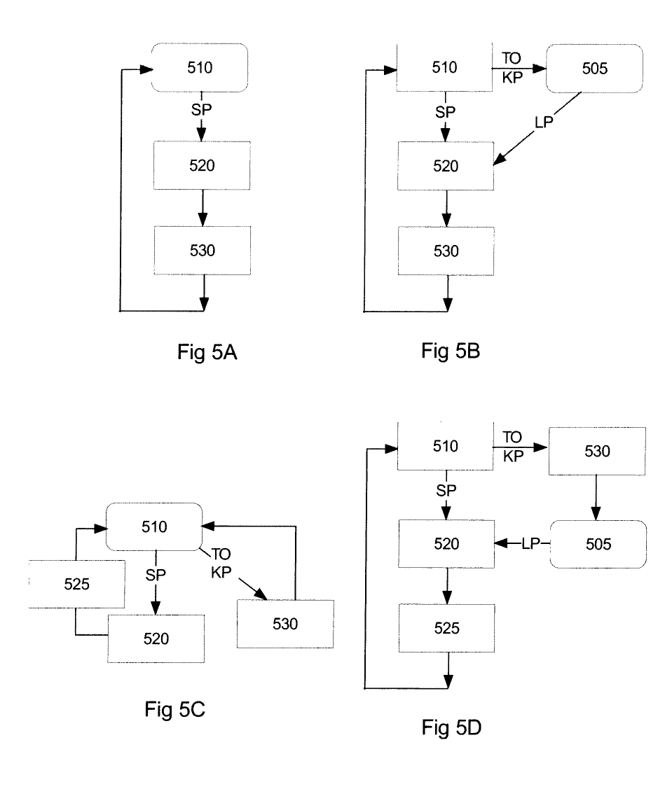

FIG. 4a shows a device 400 according to the teachings herein which will be described with simultaneous reference to FIG. 5, esp. FIG. 5A which shows a flow chart of a method according to the teachings herein. The device 400 is, in this exemplary embodiment, a mobile phone such as is described with reference to FIG. 2 and incorporates a user interface operatively coupled to the display 403 and the volume keys 407 and 408.

In an initial state 510, a first mode or profile is active in the mobile phone 400. As a user presses either of the volume keys 207 and 208 a second state 520 is entered through state transition 410 where a second mode is determined after which the user interface switches from the first mode to the second mode, state transition 420 to state 530. The user interface then returns to the initial state 510 through state transition 430.

In FIG. 4 a graphical representation 409 of the currently active mode is displayed on the display 403. In this embodiment it is on the form of a note indicating that an audible sound level is currently used. As the second mode is activated or switched to in step or state 530 a different icon 409′ is displayed indicating the switch. In this embodiment the icon is a crossed-over note indicating that the profile or mode is silent.

As a user continues to press either of the volume keys 207 and 208 the steps above are repeated and new modes or profiles are activated.

By associating the profiles with the volume key a logical connection is established between the keys and the profile switching as the profiles are most commonly associated with different sound levels for the user interface. Thus the alternative function of the volume keys is easy to deduce and intuitive to understand and use. Furthermore there is none or little collision with the use of the volume keys' other associated functions such as increasing or decreasing the earphone volume during an ongoing call. During an ingoing call it makes no or little sense to change the profile as all indications of incoming communications are often muted in any case.

However, to avoid functional collision with other applications and functions associated with the volume keys, such as adjusting the volume of a loud speaker, zoom of a camera or adjusting the ringing volume for incoming calls, ie rendering the method and device as described herein more adaptable to cooperate with other applications, an initial state 505, see FIG. 5B, is applied. In this initial state 505 representing an idle mode or that another application is active, such as the media player, the user interface is configured to detect a long press on any of the volume keys 407 and 408. A long press is commonly known as a press on a specific key which press lasts longer than a pre-specified time.

As a long-press (LP) on a volume key 407, 408 is detected the user interface determines which mode or profile that should be switched to through a transition to state 520. And a switch to this mode is executed through a transition to state 530 after which the user interface returns to state 510 where further key-presses (SP) on the volume keys 407 and 408, which does not have to be long-presses, determines further profile switches. After a timeout (TO) has expired with no further key-presses (SP) on the volume keys 407, 408 in state 510 or if another key (KP) is pressed the user interface transits to the initial state 505.

It should be noted that in an alternative embodiment the switch to a new profile is not executed until a timeout has lapsed or other key has been pressed. In this embodiment a notification of which profile or mode that is determined to be switched to will be displayed in a state 525 to a user, either by an icon or by displaying a list of the available profiles and marking which profile will be switched to. See FIG. 5C.

It should be noted that in one embodiment the methods of FIG. 5B and C are combined so that a profile switch is executed upon the return transition to state 505 from state 510 through state 530 and a notification is displayed upon transition to state 510 through state 525, see FIG. 5D.

In one embodiment the available profiles are arranged in a list and as a volume key press is detected a second state is chosen from this list.

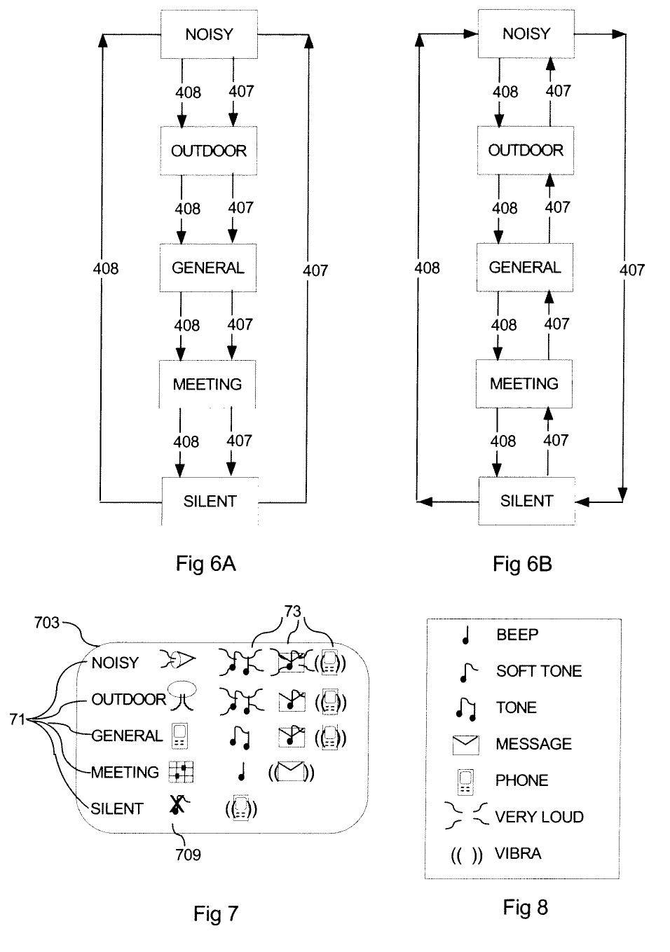

FIG. 6 shows some examples of such lists. In FIG. 6 a list of five modes or profiles is shown, NOISY, OUTDOOR, GENERAL, MEETING and SILENT. Table 1 shows possible settings for these profiles.

In FIG. 6A the list of modes is circular and for any detected press on either of the volume keys 407 and 408 the next mode or profile is selected. As the end of the list is reached the first mode of the list is selected. This makes it easy for a user to quickly change the profile in that the right key does not have to be found. A press on any of the volume keys will have the same effect. This can be beneficial if the user is wearing thick gloves or such as the volume keys 407 and 408 are often made quite small so as to reduce the overall size of the device 400.

In one embodiment the controller determining the next mode is always returned to the start of the list.

In one embodiment the controller stays at the currently active mode.

In one embodiment the list is rearranged after each switch so that the mode switched to is brought to the top of the list. This will ensure that the most commonly used lists are at the top of the list and it will thus be easier and require fewer key presses to switch to another commonly used mode. For example, if a user only uses the profiles SILENT and GENERAL these two modes will be on the top of the list, alternating on the very top and switching between them will always only require one volume key press

In FIG. 6B the profiles have been listed in order of loudness and a press on the volume up key 407 switches to a profile that is generally set to be louder and a press on the volume down key 408 switches to a profile that is generally set to be softer.

The graphical notifications 409 indicate which profile is currently active and are chosen to be illustrative of the mode's or profile's settings. However, as a device or user interface is configured with a multitude of profiles it can be difficult for a user to remember or deduce which profile had which settings and the commonly used note and crossed-over note indicating an audible and a silent profile is not sufficient to convey this information to a user. This problem is also apparent when a user wants to scroll through the profiles to choose a new profile or perhaps decide which profile should be changed to accommodate some specific needs of the user, or even to see if there already is an existing profile that fits these special needs which profile the user did not know about or remembered. Prior art solutions have included listing the profiles one by one and showing the settings details under the profile name and thereby providing the user with a view of the settings and an easy access to changing these settings. A disadvantage of this is that due to the limited screen space only one profile and its settings are shown at a time and a user has to scroll through the whole list to see the available profiles. This is both time consuming and requires a mental effort in that the settings will have to be browsed through and remembered for each profile, which also requires extensive eye-movements.

FIG. 7 shows a screen view of a user interface and a device according to an embodiment and FIG. 8 shows a listing of graphical notifications or icons and their meaning.

In the screen view 703 a list of profiles or modes 71 is displayed. Adjacent to these profiles 71 an identifying icon 709 is displayed for each profile. In the exemplary embodiment of FIG. 7 the profiles and their corresponding icons are: (NOISY; a bugle), (OUTDOOR; a tree), (GENERAL; a phone), (MEETING; a calendar view), (SILENT; a crossed-over note). These icons are chosen to be illustrative of the purpose of the profile or its suggested use. This allows a user to quickly identify the profile and to associate each icon to the corresponding profile which is of use when only an icon is displayed indicating which profile is being used.

It should be noted that in some embodiments only the profile names 71 are displayed and in some only the identifying icons 709 are shown.

Furthermore, adjacent the profile list 71 and the identifying icons 709 setting icons 73 are displayed. These setting icons are explained in FIG. 8. A combination of individual setting icons can be used to provide the user with information on how the user interface will be used under the associated profile 71. For example, an envelope or MESSAGE icon combined with a BEEP icon indicates that a beep is sounded as a message arrives. A VIBRA indication combined with a PHONE or DEVICE (not shown) shows that as a notification is to be given the phone or device will vibrate. An envelope or MESSAGE icon combined with a VIBRA and a BEEP indicates that the device will sound a beep and vibrate as a message arrives. A SOFT TONE indicates that a soft or short tone will be played and a TONE combined with a VERY LOUD icon indicates that a tone will be played very loudly as a notification is given, such as for an incoming call.

In the exemplary embodiment of FIG. 7 the profile SILENT is set to not play any sounds for any notifications, but only to vibrate, MEETING is set to sound a beep for incoming calls and to vibrate for incoming messages, GENERAL is set to play a ringing tune for incoming calls, a softer or shorter tune for incoming messages and to vibrate for all notifications, OUTDOOR is set to play a very loud tune for incoming calls, play a tune for incoming messages and to vibrate for all notifications and NOISY is set to play a very loud tune for incoming calls, play a very loud, but short, tune for incoming messages and to vibrate for all notifications.

Thus the user can quickly deduce which settings are used for each of the profiles 71 displayed. This will guide the user into selecting the appropriate profile and also to choose which would be easiest to modify to the users particular needs.

In one embodiment the notifying icons 409 comprise the identifying icons 709 and in one embodiment the notifying icons 409 comprise both the identifying icons 709 and the settings icons 73.

It should be noted that even though it has not been described herein also visual indications can be given and controlled for any operating mode. For example, the operating mode SILENT can be set to display a blinking light as a notification is to be given.

These graphical indicators can be stored in a device or alternatively downloaded from a database possibly over the internet to be stored in a device.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, MP3 players, personal organizers or any other device designed for providing more than none operating modes.

The teaching of the present application has numerous advantages. Different embodiments or implementations may yield one or more of the following advantages. It should be noted that this is not an exhaustive list and there may be other advantages which are not described herein. One advantage of the teaching of this application is that a user interface or a device provides a user with an intuitive and easy to learn and deduce access to a profile switch.

Another advantage of the teaching of the present application is that a user can easily recognize and deduce the settings for more than one profile from a listing on one screen view even on a limited display.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as music players, palmtop computers and the like. It should also be noted that there are many alternative ways of implementing the methods and apparatuses of the teachings of the present application.

The term “comprising” as used in the claims does not exclude other elements or steps. The term “a” or “an” as used in the claims does not exclude a plurality. A unit or other means may fulfill the functions of several units or means recited in the claims.

TABLE 1
modes and corresponding settings:

| | | | | Incoming |
|---|---|---|---|---|
| | Ringing | Ringing | | message |
| Mode | tune | volume | Vibrator | alert |
| NOISY | Standard | Max (10) | ON | Tune |
| OUTDOOR | Standard | Increasing | ON | Tune |
| GENERAL | Standard | Medium (5) | ON | Tune |
| MEETING | Beep | Low (2) | ON (SMS) | Beep |
| SILENT | None | Off (0) | ON | None |

1. A user interface configured to detect a first press on a volume key and upon said detection determine a second operating mode and switch from a first operating mode to said second operating mode.

2. A user interface according to claim 1, further configured to display a graphical indication of said second operating mode on a display operatively coupled to said user interface.

3. A user interface according to claim 1, further configured to detect a second press on a volume key and upon said detection determine a further second operating mode.

4. A user interface according to claim 1, further configured to detect a press on a non-volume key and upon such detection switch to said second operating mode.

5. A user interface according to claim 1, further configured to detect a timeout and upon such detection switch to said second operating mode.

6. A user interface according to claim 1, wherein said second operating mode is determined by selection from a list of operating modes.

7. A user interface according to claim 6, further configured to re-arrange said list of operating modes upon switching to said second operating mode, by inserting said second operating mode first in said list of operating modes.

8. A user interface according to claim 1, wherein said operating mode comprises control settings for at least one feature taken from a group comprising: ringing tune, vibra, ringing tune volume, incoming message alert, general notification, and incoming voice call alert.

9. A device incorporating and implementing or configured to incorporate and implement a user interface according to claim 1.

10. A computer readable medium stored in a memory including at least computer program code for controlling a user interface, said computer readable medium comprising:
software code for detecting a key press on a volume key,
software code for determining a second operating mode, and
software code for switching to said second operating mode from a first operating mode.

11. A device incorporating and implementing a computer readable medium according to claim 10.

12. A method for switching from a first operating mode to a second operating mode, comprising
detecting a first press on a volume key,
determining said second operating mode and
switching to said second operating mode.

13. A method according to claim 12, further comprising displaying a graphical indication of said second operating mode.

14. A method according to claim 12, further comprising detecting a second press on a volume key and determine a further second operating mode to be used as said operating mode.

15. A method according to claim 12, further comprising detecting a press on a non-volume key and then execute said switch to said second operating mode.

16. A method according to claim 12, further comprising detecting a time out and then execute said switch to said second operating mode.

17. A method according to claim 12, further comprising determining said second operating mode from a list of operating modes.

18. A method according to claim 12, further comprising Rearranging said list of operating modes by inserting said second operating mode in the beginning of said list of operating modes.

19. A device incorporating and implementing or configured to incorporate and implement a user interface according to claim 12.

20. A graphical indication comprising a graphical data indicative of control settings for an operating mode,wherein said graphical data comprises at least one graphical icon representative of an audible function, a visible function or a tactile function.

21. A user interface configured to display a graphical indication of an operating mode according to claim 20 on a display.

22. A user interface according to claim 20, further configured to display a list of operating modes and corresponding graphical indications according indicating control settings for each operating mode.

23. A device incorporating and implementing a user interface according to claim 21.

24. A method of displaying graphical indicators according to claim 20 comprising displaying a list of operating modes and for each displayed operating mode display a corresponding graphical indicator indicating control settings for the corresponding operating mode.
